(19) United States
(12) Patent Application Publication
(10) Pub. No.: US 2026/0142184 A1
(43) Pub. Date: May 21, 2026

(54) NEGATIVE ELECTRODE ACTIVE MATERIAL FOR SECONDARY BATTERY, SECONDARY BATTERY, AND METHOD FOR MANUFACTURING NEGATIVE ELECTRODE ACTIVE MATERIAL FOR SECONDARY BATTERY

(71) Applicant: Panasonic Energy Co., Ltd., Moriguchi-shi, Osaka (JP)

(72) Inventors: Shigeki Moriya, Osaka Fu (JP); Isao Koizumi, Osaka Fu (JP)

(73) Assignee: Panasonic Energy Co., Ltd., Moriguchi-shi, Osaka (JP)

(21) Appl. No.: 19/113,628

(22) PCT Filed: Sep. 26, 2023
(86) PCT No.: PCT/JP2023/034939

§ 371 Date: Mar. 20, 2025

(30) Foreign Application Priority Data
Sep. 30, 2022 (JP) 2022-158791

(51) Int. Cl. H01M 4/62; H01M 4/02; H01M 4/36; H01M 4/58; H01M 4/587; H01M 10/052

(52) U.S. Cl. CPC H01M 4/628; H01M 4/364; H01M 4/366; H01M 4/5825; H01M 4/587; H01M 10/052; H01M 2004/027

(57) ABSTRACT

A negative electrode material for secondary batteries includes a composite material. The composite material includes a carbon phase, and silicon phases dispersed in the carbon phase. At least a part of surfaces of the silicon phases is covered with a coating layer, and the coating layer contains a lithium silicate.

### TECHNICAL FIELD

The present disclosure relates to a negative electrode active material for secondary batteries, a secondary battery, and a method for producing a negative electrode active material for secondary batteries.

### BACKGROUND ART

In a negative electrode of secondary batteries represented by lithium-ion secondary batteries which includes a negative electrode active material capable of absorbing and releasing lithium ions, graphite has been typically used as such a negative electrode active material. In recent years, with respect to the negative electrode active material, studies have been made on a composite material containing silicon, which has a larger capacity density than graphite (e.g., Patent Literature 1).

### CITATION LIST

### Patent Literature

Patent Literature 1: International Publication WO2020/110917

### SUMMARY OF INVENTION

### Technical Problem

A composite material in which silicon phases are dispersed in a carbon phase is produced by forming a raw material silicon while being pulverize and a carbon source into a composite using a ball mill. However, the surface of the raw material silicon is oxidized during pulverization, and surfaces of the silicon phases in the composite material are covered with an oxide film (SiO₂), tending to lower the charge-discharge efficiency.

### Solution to Problem

In view of the above, one aspect of the present disclosure relates to a negative electrode active material for secondary batteries, including a composite material, wherein the composite material includes a carbon phase, and silicon phases dispersed in the carbon phase, at least a part of surfaces of the silicon phases is covered with a coating layer, and the coating layer contains a lithium silicate.

Another aspect of the present disclosure relates to a secondary battery, including a positive electrode, a negative electrode, and an electrolyte, wherein the negative electrode includes the above-described negative electrode active material.

Still another aspect of the present disclosure relates to a method for producing a negative electrode active material for secondary batteries, the method including: a first step of adding at least one additive selected from the group consisting of LiAlH₄ and LiBH₄ to a raw material silicon and performing a pulverization treatment, in an inert atmosphere; a second step of heat-treating a mixture of the raw material silicon and the additive having been subjected to the pulverization treatment, in an inert atmosphere, to convert a surface of the raw material silicon into lithium silicate; and a third step of adding a carbon source to the raw material silicon with the surface converted into lithium silicate and performing a composite formation treatment, in an inert atmosphere.

### Advantageous Effects of Invention

According to the present disclosure, it is possible to suppress the lowering of the initial charge-discharge efficiency of a secondary battery.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic sectional view of a negative electrode active material (composite material) according to one embodiment of the present disclosure.

FIG. 2 A partially cut-away schematic oblique view of a secondary battery according to one embodiment of the present disclosure.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

### (Negative Electrode Active Material for Secondary Batteries)

A negative electrode active material for secondary batteries according to one embodiment of the present disclosure includes a composite material. The composite material includes a carbon phase and silicon phases dispersed in the carbon phase. At least a part of surfaces of the silicon phases is covered with a coating layer, and the coating layer contains a lithium silicate.

By covering the silicon phases with a coating layer including a lithium silicate, the irreversible capacity of the composite material can be reduced as compared to when the surfaces of the silicon phases are covered with an oxide film. This suppresses the lowering of the initial charge-discharge efficiency resulted from the surfaces of the silicon phases being covered with an oxide film.

### (Coating Layer)

The coating layer contains a lithium silicate, and contains almost no SiO₂. Lithium silicate has a very small irreversible capacity as compared to SiO₂. The proportion of the lithium silicate in the coating layer may be 80 mass % or more, and may be 90 mass % or more. Lithium silicates are constituted of Li, Si, and O. In view of the reduction in irreversible capacity and the chemical stability, the lithium silicate may include at least one selected from the group consisting of Li₂Si₂O₅, Li₂SiO₃, and Li₄SiO₄. The lithium silicate may contain a small amount of another element (e.g., a later-described element A) other than Li, Si, and O.

The coating layer may contain at least one element A selected from the group consisting of aluminum (Al) and boron (B). When the element A is contained, the viscosity of SiO₂ decreases in the process of forming a coating layer, to facilitate the formation of a lithium silicate through the reaction of Li and SiO₂, and a favorable ion conductivity is likely to be obtained. The element A is derived from a later-described additive (at least one of LiAlH₄ and LiBH₄). The element A can be contained, for example, in a solid solution state in the lithium silicate. The element A may be contained as a compound containing the element A, Si, and O (e.g., aluminum silicate, borosilicate), and may be contained as a compound containing Li, the element A, and O (e.g., lithium aluminate, lithium borate).

The content of the element A in the composite material is preferably 0.02 mass % or more and 1.1 mass % or less, more preferably 0.2 mass % or more and 1.1 mass % or less, relative to the total mass of the composite material. The content of the element A in the composite material is synonymous with the sum of the contents of Al and B in the composite material. When the content of the element A in the composite material is 0.02 mass % or more, the coating layer is sufficiently formed, and the lowering of the charge-discharge efficiency can be easily suppressed. When the content of the element A in the composite material is 1.1 mass % or less, the coating layer is formed in an appropriate thickness, allowing the absorption and release of lithium ions by the silicon phases to proceed smoothly.

The content of the element A (Al, B) in the composite material can be determined by inductively coupled plasma (ICP) emission spectrometry. Specifically, the composite material is dissolved in a heated acid solution (mixed acid of hydrofluoric acid and nitric acid), and carbon of the solution residue is removed by filtration, to obtain a filtrate as a sample liquid. ICP emission spectrometry is performed on the sample liquid.

In a cross section of a particle of the composite material, the coverage rate of the surfaces of the silicon phases with the coating layer may be 40% or more, may be 60% or more, may be 90% or more, and may be 100%. When the above coverage rate is 90% or more, the formation of an oxide film on the surfaces of the silicon phases is sufficiently suppressed, and the lowering of the charge-discharge efficiency can be easily suppressed.

The above coverage rate can be determined as follows.

With respect to a cross section of a particle of the composite material, analysis by transmission electron microscopy (TEM) and electron energy loss spectroscopy (EELS) (hereinafter referred to as “TEM-EELS analysis”) is performed. Specifically, one silicon phase (island portion) is randomly selected from a TEM cross-sectional image (e.g., a region of 300 nm×300 nm) of a particle of the composite material, to measure a length L1 of the outline of the silicon phase. EELS elemental mapping is performed to measure a length L2 of the outline of a region where at least one of Li and the element A, Si, and O are distributed, on the surface of the silicon phase. (L2/L1)×100 is determined as the above coverage rate. With respect to 5 to 10 silicon phases, the coverage rates are determined and averaged. Here, the silicon phase subjected to the measurement are those having a maximum diameter of 100 nm or more.

The area ratio of the coating layer in a cross section of a particle of the composite material may be 0.01% or more and 5% or less, and may be 0.1% or more and 1% or less. When the above area ratio of the coating layer is 5% or less, a sufficiently high content of the carbon phase and the silicon phases in the composite material is ensured, making it easy to achieve high capacity and improved cycle characteristics. When the above area ratio of the coating layer is 0.01% or more, the coating layer is sufficiently formed, and the lowering of the charge-discharge efficiency can be easily suppressed.

The above area ratio of the coating layer can be determined as follows. TEM-EELS analysis is performed on a cross section of a particle of the composite material. An area S0 (e.g., 150 nm×150 mu) of the entire region of a TEM image is measured. An area S1 of the coating layer covering the silicon phase surface in the TEM image (the region in which at least one of Li and the element A, Si, and O are distributed, obtained by EELS elemental mapping) is measured. S1/S0×100 is determined as the above area ratio of the coating layer.

### (Composite Material)

The composite material includes a carbon phase having ion conductivity and silicon phases (in one respect, silicon particles) dispersed in the carbon phase. The silicon phases are covered with a coating layer including a lithium silicate. The composite material containing a carbon phase is flexible and highly conductive, so that a favorable conductive network can be maintained in the negative electrode. Even though a void is formed around the composite material or a crack occurs in the composite material, partial isolation of the composite material is unlikely to occur, and the contact between the composite material and its surroundings is likely to be maintained. Therefore, the capacity decrease during repeated charge-discharge cycles can be easily suppressed.

The composite material can be present in the form of particles each having a sea-island structure. The silicon phases (islands) having a coating layer are dispersed in the matrix (sea) of the carbon phase. With the sea-island structure, the contact of the silicon phases with the electrolyte is limited, leading to suppressed side reactions. During charging, the silicon phases absorb lithium ions and expand. During discharging, the silicon phases release lithium ions and contract. The stress caused due to expansion and contraction of the silicon phases is relaxed by the matrix of the carbon phase.

The carbon phase may be constituted of, for example, amorphous carbon (formless carbon), rather than a material with a developed graphite-like crystal structure such as a graphite material. Examples of the amorphous carbon that constitutes the carbon phase include hard carbon, soft carbon, and other amorphous carbon. Amorphous carbon is a carbon material having an average interplanar spacing d002 of the (002) plane measured by X-ray diffractometry exceeding 0.34 nm.

The average particle diameter of the silicon phases dispersed in the carbon phase may be 1 nm or more, or 5 nm or more. The above average particle diameter may be 1000 nm or less, 500 nm or less, 200 nm or less, 100 nm or less, or 50 nm or less. Fine silicon phases are preferable in that their volume changes during charging and discharging are small, leading to improved structural stability of the composite material.

The average particle diameter of the silicon phases can be measured by cross-sectional observation of a particle of the composite material using a TEM or SEM (scanning electron microscope). Specifically, it can be determined by averaging the maximum diameters of 100 randomly selected particulate silicon phases.

The crystallite size of the silicon phases is preferably 30 nm or less. When the crystallite size is 30 nm or less, the volume change of the silicon-containing material due to expansion and contraction of the silicon phases associated with charging and discharging can be further reduced. The crystallite size is more preferably 30 nm or less, even more preferably 20 nm or less. When the crystallite size is 20 nm or less, the expansion and contraction of the silicon phases become even, the microcracks of the silicon phase are reduced, and the cycle characteristics can be further improved.

The crystallite size of the silicon phases is calculated using the Scherrer's equation from the half-value width of a diffraction peak belonging to the Si (111) plane in an X-ray diffraction pattern of the silicon phases.

In view of achieving high capacity, the content of the silicon phases in the composite material may be 30 mass % or more, and may be 40 mass % or more, relative to the total mass of the composite material. In view of improving the cycle characteristics, the content of the silicon phases in the composite material may be 60 mass % or less, and may be 50 mass % or less, relative to the total mass of the composite material. When the content of the silicon phases is 50 mass % or less, the ratio of the carbon phase is large, and the carbon phase is likely to enter the void formed in association with charging and discharging, which, for example, allows the conductive paths between the composite material and its surroundings to be easily maintained.

The average particle diameter (D50) of the composite material may be 1 μm or more, or 5 μm or more, and may be 20 μm or less, 15 μm or less, or 10 μm or less. The average particle diameter (D50) means a median diameter (diameter at 50% cumulative volume) in a volume-based particle size distribution measured by a laser diffraction-scattering type particle size distribution meter. For the measurement, for example, a laser diffraction type particle size distribution analyzer “SALD-2000A” available from Shimadzu Corporation can be used.

The content of the silicon phases in the composite material can be determined by inductively coupled plasma (ICP) emission spectrometry. Specifically, the composite material is dissolved in a heated acid solution (mixed acid of hydrofluoric acid and nitric acid), and carbon of the solution residue is removed by filtration, to obtain a filtrate as a sample liquid. ICP emission spectrometry is performed on the sample liquid.

The content of the carbon phase in the composite material can be determined using a carbon/sulfur analyzer (e.g. EMIA-520 available from HORIBA, Ltd.).

Elemental analysis (composition analysis) of the sea portions, the island portion, and the coating layer in a particle of the composite material having a sea-island structure can be performed by TEM-EELS analysis on a cross section of a particle of the composite material.

The composition of the lithium silicate contained in the coating layer can be determined by X-ray diffraction (XRD) measurement using CuKα rays. For example, a peak of the 011 plane of Li₄SiO₄ appears at a diffraction angle 2θ=21.9° to 22.5°. A peak of the 111 plane of Li₂SiO₃ appears at a diffraction angle 2θ=27.40 to 29.4°. A peak of the 040 plane of Li₂Si₂O₅ appears at a diffraction angle 2θ=24.4° to 25.0°.

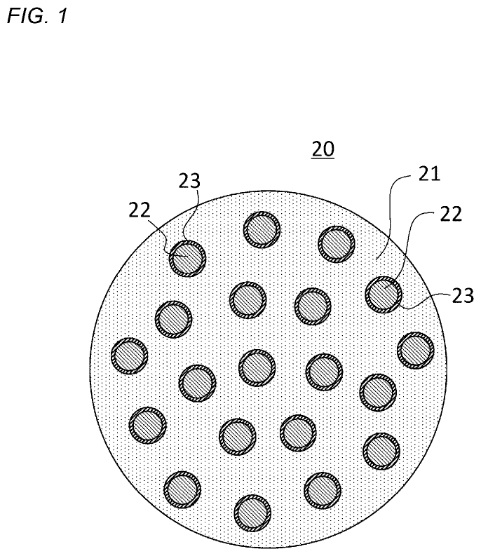

FIG. 1 schematically shows a cross section of a composite material particle 20.

The composite material particle 20 includes a carbon phase 21 and silicon phases 22 dispersed in the carbon phase 21. The composite material particle 20 has a sea-island structure in which the fine silicon phases 22 are dispersed in a matrix of the carbon phase 21. At least a part of surfaces of the silicon phases 22 is covered with a coating layer 23. The coating layer 23 contains a lithium silicate.

### (Method for Producing Negative Electrode Active Material for Secondary Batteries)

A method for producing a negative electrode active material (composite material) for secondary batteries according to an embodiment of the present disclosure includes the following first to third steps.
First step: In an inert atmosphere, at least one additive selected from the group consisting of LiAlH₄ and LiBH₄ is added to a raw material silicon, and a pulverization treatment is performed.
Second step: In an inert atmosphere, a mixture of the raw material silicon and the additive having been subjected to the pulverization treatment is heat-treated, to convert the surface of the raw material silicon into lithium silicate.
Third step: In an inert atmosphere, a carbon source is added to the raw material silicon with the surface converted into lithium silicate, and a composite formation treatment is performed.

### (First Step: Pulverization Step)

In the first step, a raw material silicon and an additive are pulverized while being mixed, using a pulverizer like a ball mill. In this way, the raw material silicon is micronized by pulverization, and the additive is distributed on the surface or around the pulverized raw material silicon. At this time, the oxidation of the surface of the raw material silicon is suppressed to some extent because the additive has a reducing effect. Examples of the inert atmosphere include a nitrogen atmosphere and an argon atmosphere.

In the first step, the additive is added preferably in an amount of 0.1 parts by mass or more and 3 parts by mass or less per 100 parts by mass of the raw material silicon. When the added amount of the additive is 0.1 mass % or more per 100 parts by mass of the raw material silicon, the coating layer is sufficiently formed, and the lowering of the charge-discharge efficiency can be easily suppressed. When the added amount of the additive is 3 mass % or less per 100 parts by mass of the raw material silicon, the coating layer is formed in an appropriate thickness, allowing the absorption and release of lithium ions by the silicon phases to proceed smoothly.

### (Second Step: Silicatization Step)

A thin oxide film (SiO2) is formed to some extent on the surface of the pulverized raw material silicon. In the second step, the oxide film on the surface of the pulverized raw material silicon is converted into lithium silicate. Heat treating allow the additive to be liquefied, which covers the Si fine particles and react with the oxide film on the surfaces of the Si fine particles, so that a coating layer containing a lithium silicate is formed on the surfaces of the Si fine particles. At this time, at least one of Al and B derived from the additive can be included in the coating layer.

For easily covering the surface of the raw material silicon with the additive, the heat-treating temperature in the second step is preferably equal to or higher than the melting point of the additive (e.g., 270° C. or higher). The heat-treating temperature in the second step is preferably 500° C. or lower. By performing the heat-treating in the second step at a temperature as low as 500° C. or less, even when heat-treating in a step 3b is performed at a high temperature, the crystallinity of the silicate is suppressed low to some extent, and the ion conductivity of the coating layer containing the silicate is likely to be ensured.

### (Third Step: Composite Formation Step)

The third step includes, for example, the following steps 3a to 3b.
Step 3a: In an inert atmosphere, the raw material silicon and a carbon source are mixed together, using a pulverizer like as a ball mill.
Step 3b: In an inert atmosphere, the mixture is heat-treated, to carbonize the carbon source to produce formless carbon.

### (Step 3a)

In the step 3a, mixing is performed using a pulverizer like a ball mill. That is, the mixture is formed into a composite while being pulverized. At this time, the raw material silicon is pulverized, and silicon phases are produced. The silicon phases are dispersed in a matrix of the carbon source. That is, a composite intermediate in which the silicon phases are dispersed in a matrix of the carbon source is formed. Although the raw material silicon may have a surface which has been newly formed by pulverization, the oxidation of the newly-formed surface is suppressed since this surface is sufficiently covered with the carbon source.

Examples of the carbon source that can be used include water-soluble resins, such as carboxymethyl cellulose (CMC), hydroxyethyl cellulose, polyacrylates, polyacrylamide, polyvinyl alcohol, polyethylene oxide, and polyvinylpyrrolidone, saccharides, such as cellulose and sucrose, petroleum pitch, coal pitch, and tar, but are not limited thereto.

The step 3a can be performed by dry mixing, and may be performed by wet mixing, with a dispersion medium added to the raw material silicon and the carbon source. In the case of wet mixing, the dispersion medium is removed by drying after mixing. Examples of the dispersion medium that can be used include alcohols, ethers, fatty acids, alkanes, cycloalkanes, silicate esters, and metal alkoxides.

### (Step 3b)

In the step 3b, the mixture (the composite intermediate in which the silicon phases are dispersed in a matrix of the carbon source) is heat-treated, to carbonize the carbon source to produce formless carbon, and thus to obtain a sintered product. That is, in the step 3b, a composite material in which the silicon phases are dispersed in the carbon phase including formless carbon is obtained. Thereafter, the sintered product is crushed, to obtain particles of the composite material.

The heat-treating temperature in the step 3b for conversion into formless carbon is, for example, 700° C. to 1200° C.

### (Secondary Battery)

A secondary battery according to an embodiment of the present disclosure includes a positive electrode, a negative electrode, and an electrolyte. The negative electrode includes the above-described negative electrode active material for secondary batteries. Description will be given below of the negative electrode, etc. of the secondary battery.

### [Negative Electrode]

The negative electrode includes a negative electrode active material capable of absorbing and releasing lithium ions. The negative electrode active material includes the above-described composite material.

The negative electrode active material may further include another active material substance. A preferred example of another active material substance is a carbon-based active material. The composite material expands and contracts in volume in association with charging and discharging. Therefore, increasing the ratio thereof in the negative electrode active material tends to cause a contact failure between the negative electrode active material and the negative electrode current collector in association with charging and discharging. On the other hand, by using the composite material in combination with a carbon-based active material, it becomes possible to achieve excellent cycle characteristics, while imparting the high capacity of the silicon phases to the negative electrode. The proportion of the composite material in the total of the composite material and the carbon-based active material may be, for example, 1 mass % or more and 15 mass % or less. This makes it easy to achieve both high capacity and improved cycle characteristics.

Examples of the carbon-based active material include graphite, graphitizable carbon (soft carbon), and non-graphitizable carbon (hard carbon). In particular, graphite is preferred, in terms of its excellent stability during charging and discharging and its small irreversible capacity. Graphite means a material having a graphite-like crystal structure, and, in general, refers to a carbon material having an average interplanar spacing d002 of the (002) plane measured by X-ray diffractometry of 0.34 nm or less. Examples thereof include natural graphite, artificial graphite, and graphitized mesophase carbon particles. The carbon-based material may be used singly or in combination of two or more kinds.

The negative electrode includes, for example, a negative electrode current collector, and a negative electrode mixture layer supported on a surface of the negative electrode current collector. The negative electrode mixture layer can be formed by applying a negative electrode slurry of a negative electrode mixture dispersed in a dispersion medium, onto a surface of the negative electrode current collector, followed by drying. The applied film after drying may be rolled as necessary. The negative electrode mixture layer may be formed on one surface or both surfaces of the negative electrode current collector.

The negative electrode mixture contains a negative electrode active material as an essential component, and, as optional components, can contain a binder, a conductive agent, a thickener, and the like.

As the negative electrode current collector, a non-porous conductive substrate (metal foil, etc.) and a porous conductive substrate (mesh, net, punched sheet, etc.) are used. Examples of the material of the negative electrode current collector include stainless steel, nickel, nickel alloy, copper, and copper alloy. The thickness of the negative electrode current collector is not particularly limited, but is preferably 1 to 50 μm, more preferably 5 to 20 μm, in view of the balance between high strength and lightweight of the negative electrode.

Examples of the binder include fluorocarbon resins, polyolefin resins, polyamide resins, polyimide resins, vinyl resins, styrene-butadiene copolymer rubber (SBR), polyacrylic acids, and derivatives thereof. These may be used singly or in combination of two or more kinds.

Examples of the conductive agent include carbon black, conductive fibers, fluorinated carbon, and organic conductive materials. These may be used singly or in combination of two or more kinds.

Examples of the thickener include carboxymethyl cellulose (CMC), and polyvinyl alcohol. These may be used singly or in combination of two or more kinds.

Examples of the dispersion medium include water, alcohols, ethers, N-methyl-2-pyrrolidone (NMP), and mixed solvents thereof.

### [Positive Electrode]

The positive electrode includes a positive electrode active material capable of absorbing and releasing lithium ions.

As the positive electrode active material, a lithium-metal composite oxide can be used. Examples of the lithium-metal composite oxide include LiₐCoO₂, LiₐNiO₂, LiₐMnO₂, LiₐCo_{b}Ni_{1-b}O₂, LiₐCo_{b}M_{1-b}O_{c}, LiₐNi_{1-b}Mn₂O_{c}, LiₐMn₂O₄, LiₐMn_{2-b}M_{b}O₄, LiMePO₄, and Li₂MePO₄F. Here, M is at least one selected from the group consisting of Na, Mg, Sc, Y, Mn, Fe, Co, Ni, Cu, Zn, Al, Cr, Pb, Sb, and B. Me includes at least a transition element (e.g., at least one selected from the group consisting of Mn, Fe, Co, and Ni). Here, 0≤a≤1.2, 0≤b≤0.9, and 2.0≤c≤2.3. The value “a” representing the molar ratio of lithium increases and decreases during charging and discharging.

The positive electrode includes, for example, a positive electrode current collector, and a positive electrode mixture layer supported on a surface of the positive electrode current collector. The positive electrode mixture layer can be formed by applying a positive electrode slurry of a positive electrode mixture dispersed in a dispersion medium, onto a surface of the positive electrode current collector, followed by drying. The applied film after drying may be rolled as necessary. The positive electrode mixture layer may be formed on one surface or both surfaces of the positive electrode current collector.

The positive electrode mixture contains a positive electrode active material as an essential component, and, as optional components, can contain a binder, a conductive agent, and the like.

As the binder and the conductive agent, those as exemplified for the negative electrode can be used. As the conductive agent, graphite, such as natural graphite and artificial graphite, may also be used.

The shape and the thickness of the positive electrode current collector can be respectively selected from the shapes and the ranges corresponding to those of the negative electrode current collector. Examples of the material of the positive electrode current collector include stainless steel, aluminum, aluminum alloy, and titanium.

### [Electrolyte]

The electrolyte (or electrolyte solution) contains a solvent, and a lithium salt dissolved in the solvent. The concentration of the lithium salt in the electrolyte is, for example, 0.5 to 2 mol/L. The electrolyte may contain a known additive.

The solvent may be an aqueous solvent or a nonaqueous solvent. As the nonaqueous solvent, for example, a cyclic carbonic acid ester, a chain carbonic acid ester, a cyclic carboxylic acid ester, and the like are used. Examples of the cyclic carbonic acid ester include propylene carbonate (PC), and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL), and γ-valerolactone (GVL). The nonaqueous solvent may be used singly or in combination of two or more kinds.

Examples of the lithium salt include a lithium salt of a chlorine-containing acid (LiClO₄, LiAlCl₄, LiB₁₀Cl₁₀, etc.), a lithium salt of a fluorine-containing acid (LiPF₆, LiBF₄, LiSbF₆, LiAsF₆, LiCF₃SO₃, LiCF₃CO₂, etc.), a lithium salt of a fluorine-containing acid imide (LiN(CF₃SO₂)₂, LiN(CF₃SO₂)(C₄F₉SO₂), LiN(C₂F₅SO₂)₂, etc.), and a lithium halide (LiCl, LiBr, LiI, etc.). The lithium salt may be used singly or in combination of two or more kinds.

### [Separator]

Usually, it is desirable to interpose a separator between the positive electrode and the negative electrode. The separator is excellent in ion permeability and has moderate mechanical strength and electrically insulating properties. As the separator, for example, a microporous thin film, a woven fabric, a nonwoven fabric, and the like can be used. As the material of the separator, for example, a polyolefin, such as polypropylene and polyethylene, can be used.

As an example of the structure of the secondary battery, a structure in which an electrode group formed by winding the positive electrode and the negative electrode with the separator interposed therebetween is housed in an outer body, together with the nonaqueous electrolyte is exemplified. Instead of the wound-type electrode group, a different form of electrode group may be adopted, such as a stacked-type electrode group formed by stacking the positive electrode and the negative electrode with the separator interposed therebetween. The secondary battery may be in any form, such as cylindrical type, prismatic type, coin type, button type, and laminate type.

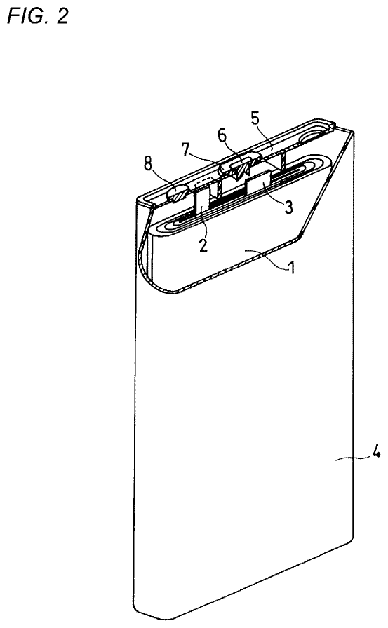

Description will be given below of the structure of a prismatic secondary battery as an example of the secondary battery according to an embodiment of the present disclosure, with reference to FIG. 2. FIG. 2 is a partially cut-away schematic oblique view of the secondary battery according to an embodiment of the present disclosure.

The battery includes a bottomed prismatic battery case 4, and an electrode group 1 and an electrolyte solution (not shown) housed in the battery case 4. The electrode group 1 includes a long belt-shaped negative electrode, a long belt-shaped positive electrode, and a separator interposed therebetween.

To a current collector of the negative electrode, a negative electrode lead 3 is attached at its one end by welding or the like. The other end of the negative electrode lead 3 is electrically connected to the negative electrode terminal 6. The negative electrode terminal 6 is insulated from a sealing plate 5 by a gasket 7 made of resin. To a current collector of the positive electrode current collector, a positive electrode lead 2 is attached at its one end by welding or the like. The other end of the positive electrode lead 2 is electrically connected to the sealing plate 5.

The periphery of the sealing plate 5 is fitted into the open end of the battery case 4, and the fitted portion is laser welded. In this way, the opening of the battery case 4 is sealed with the sealing plate 5. The injection port for electrolyte solution provided in the sealing plate 5 is closed by a sealing plug 8.

### SUPPLEMENTARY NOTES

The above description of embodiments discloses the following techniques.

### (Technique 1)

A negative electrode active material for secondary batteries, comprising
a composite material, wherein
the composite material includes a carbon phase, and silicon phases dispersed in the carbon phase,
at least a part of surfaces of the silicon phases is covered with a coating layer, and
the coating layer contains a lithium silicate.

### (Technique 2)

The negative electrode active material for secondary batteries according to technique 1, wherein the coating layer contains at least one element A selected from the group consisting of aluminum and boron.

### (Technique 3)

The negative electrode active material for secondary batteries according to technique 1 or 2, wherein a content of the element A in the composite material is 0.02 mass % or more and 1.1 mass % or less, relative to a total mass of the composite material.

### (Technique 4)

The negative electrode active material for secondary batteries according to any one of techniques 1 to 3, wherein a content of the silicon phases in the composite material is 50 mass % or less, relative to a total mass of the composite material.

### (Technique 5)

The negative electrode active material for secondary batteries according to any one of techniques 1 to 4, wherein the lithium silicate includes at least one selected from the group consisting of Li₂Si₂O₅, Li₂SiO₃, and Li₄SiO₄.

### (Technique 6)

The negative electrode active material for secondary batteries according to any one of techniques 1 to 5, wherein in a cross section of a particle of the composite material, a coverage rate of the surfaces of the silicon phases with the coating layer is 40% or more.

### (Technique 7)

The negative electrode active material for secondary batteries according to any one of techniques 1 to 6, wherein an area ratio of the coating layer in a cross section of a particle of the composite material is 0.01% or more and 5% or less.

### (Technique 8)

A secondary battery, comprising
a positive electrode, a negative electrode, and an electrolyte, wherein the negative electrode includes the negative electrode active material for secondary batteries according to any one of techniques 1 to 7.

### (Technique 9)

A method for producing a negative electrode active material for secondary batteries, the method comprising:
a first step of adding at least one additive selected from the group consisting of LiAlH₄ and LiBH₄ to a raw material silicon and performing a pulverization treatment, in an inert atmosphere;
a second step of heat-treating a mixture of the raw material silicon and the additive having been subjected to the pulverization treatment, in an inert atmosphere, to convert a surface of the raw material silicon into lithium silicate; and
a third step of adding a carbon source to the raw material silicon with the surface converted into lithium silicate and performing a composite formation treatment, in an inert atmosphere.

### (Technique 10)

The method for producing a negative electrode active material for secondary batteries according to technique 9, wherein a heat-treating temperature in the second step is 270° C. or higher and 500° C. or lower.

### (Technique 11)

The method for producing a negative electrode active material for secondary batteries according to technique 9 or 10, wherein in the first step, the additive is added in an amount of 0.1 parts by mass or more and 3 parts by mass or less per 100 parts by mass of the raw material silicon.

### EXAMPLES

The present disclosure will be more specifically described below with reference to Examples. The present disclosure, however, is not limited to the following Examples.

### Examples 1 to 6 and Comparative Examples 2 and 3

### (Preparation of Composite Material)

### (First Step: Pulverization Step)

In an inert atmosphere, an additive was added to raw material silicon powder (purity≥99.9%, average particle diameter (D50) 1 μm), followed by pulverization treatment using a ball mill (first step). The pulverization treatment was performed until the average particle diameter (D50) of the raw material silicon reached 100 nm. As the additive, compounds shown in Table 1 were used. The additive was added in an amount as shown in Table 1 per 100 parts by mass of the raw material silicon.

### (Second Step: Silicatization Step)

In an inert atmosphere, the mixture of the raw material silicon and the additive having been subjected to the pulverization treatment was heat-treated at 400° C. for 5 hours (second step). In this way, the surface (oxide film) of the raw material silicon was converted into lithium silicate.

### (Third Step: Composite Formation Step)

In an inert atmosphere, coal pitch (softening point 225 to 275° C., solid carbon content≥70 mass %) serving as a carbon source was added to the raw material silicon with the surface converted into lithium silicate, and mixed together at 25° C. for 1 hour using a ball mill (step 3a). Then, the mixture was heat-treated at 850° C. for 5 hours, into a sintered product (step 3b). The sintered product was crushed using a roll crusher, and further pulverized using a jet mill until the average particle diameter (D50) reached 6 μm. In this way, a composite material was obtained as a negative electrode active material. In Table 1, a1 to a6 are composite materials (negative electrode active materials) of Examples 1 to 6, respectively, and b2 to b3 are composite materials (negative electrode active materials) of Comparative Examples 2 to 3, respectively.

The contents of Si, Al, and B in the composite material were the values shown in Table 1, respectively, relative to the total mass of the composite material. The contents of the above elements were determined by ICP emission spectroscopy. In Table 1, “-” in the column of the content of each element indicates that the measurement target element was not detected by ICP emission spectroscopy.

### Comparative Example 1

A composite material b1 was obtained as a negative electrode active material in the same manner as in Example 1, except that the raw material silicon was subjected to the pulverization treatment without adding any additive in the first step.

In the following procedure, a test cell (half-cell) was fabricated using the above-obtained composite material, and the charge-discharge efficiency of the negative electrode (composite material) was determined.

### <Fabrication of Test Cell>

### (Production of Working Electrode (Negative Electrode))

Graphite powder (average particle diameter (D50) 22 μm) was added as a negative electrode active material to the composite material. In the negative electrode active material, the mass ratio was set such that composite material:graphite=15:85.

The negative electrode active material (composite material and graphite), a sodium salt of carboxymethyl cellulose (CMC-Na), styrene-butadiene copolymer rubber (SBR), and an appropriate amount of water were mixed together, to prepare a negative electrode shiny. In the negative electrode slurry, the mass ratio was set such that (total of composite material and graphite):(CMC-Na):SBR=97.5:1.5:1.0.

The negative electrode slurry was applied onto one surface of an electrolytic copper foil (negative electrode current collector) by doctor blade method, and the applied film was dried, to form a negative electrode mixture layer. Then, the laminate of the negative electrode current collector and the negative electrode mixture layer was rolled, and cut in a predetermined size. In this way, a negative electrode was obtained.

### (Production of Counter Electrode)

A lithium metal foil was attached to one surface of an electrolytic copper foil (current collector), and punched out into a predetermined size. In this way, a counter electrode was prepared.

### (Preparation of Electrolyte Solution)

An electrolyte solution was prepared by dissolving LiPF₆ at a concentration of 1 mol/L in a mixed solvent containing ethylene carbonate (EC) and ethyl methyl carbonate (EMC) in a volume ratio of EC:EMC=3:7.

### (Assembling of Test Cell)

The negative electrode and the counter electrode were faced each other, with a separator interposed therebetween, to constitute an electrode body. The separator used here was a microporous film made of polyolefin. The electrode body was housed in an outer body constituted of an aluminum laminate sheet, and after injecting the nonaqueous electrolyte thereinto, the opening of the outer body was sealed. At this time, a part of each of the leads attached to the negative electrode and the counter electrode were exposed from the outer body. In this way, a test cell was obtained. The test cell was assembled in an argon atmosphere.

### <Charge-Discharge Test>

The test cell was constant-current charged at 0.1 C until the cell voltage reached 0.05 V, and then, constant-current discharged at 0.1 C until the cell voltage reached 1 V. The charging and discharging were performed in a 25° C. constant-temperature bath, with a rest time between charging and discharging set to 20 minutes. The charge time and the discharge time were measured, and the charge capacity (mAh/g) and discharge capacity (mAh/g) per unit mass of the negative electrode active material (mixture of composite material and graphite) were calculated.

Based on the charge and discharge capacities calculated above, and the mass ratio of composite material:graphite=15:85 in the negative electrode active material, the charge-discharge efficiency (%) of the composite material was determined from the following equation.

$$Charge - discharge efficiency = ( discharge capacity - 360 \times 0.85 ) / ( charge capacity - 380 \times 0.85 ) \times 100$$

In the equation, “380” and “360” are respectively the charge capacity (mAh/g) and the discharge capacity (mAh/g) per unit mass of graphite, which are determined by preparing a test cell in the same manner as above, except that only graphite was used as the negative electrode active material, and subjecting the test cell to charging and discharging under the same conditions as above.

The evaluation results are shown in Table 1.

TABLE 1

| | additive | | composite material | | | | | |
|---|---|---|---|---|---|---|---|---|
| | added in first step | | produced in third step | | | | with or without | charge- |
| | | added | | Si | Al | B | coating layer | discharge |
| | | amount | | content | content | content | containing | efficiency |
| | compound | (pts · mass) | No. | (mass %) | (mass %) | (mass %) | lithium silicate | (%) |
| Ex. 1 | LiAlH₄ | 1 | a1 | 50 | 0.36 | — | with | 83 |
| Ex. 2 | LiAlH₄ | 0.1 | a2 | 50 | 0.04 | — | with | 80 |
| Ex. 3 | LiAlH₄ | 3 | a3 | 50 | 1.07 | — | with | 86 |
| Ex. 4 | LiBH₄ | 1 | a4 | 50 | — | 0.25 | with | 84 |
| Ex. 5 | LiBH₄ | 0.1 | a5 | 50 | — | 0.02 | with | 81 |
| Ex. 6 | LiBH₄ | 3 | a6 | 50 | — | 0.74 | with | 85 |
| Com. Ex. 1 | no additive | — | b1 | 50 | — | — | without | 77 |
| Com. Ex. 2 | Li₂CO₃ | 1 | b2 | 50 | — | — | without | 77 |
| Com. Ex. 3 | Li₂O | 1 | b3 | 50 | — | — | without | 77 |

The composite materials a1 to a6 prepared using LiAlH₄ or LiBH₄ as the additive exhibited higher charge-discharge efficiency than the composite materials b1 to b3.

In the composite materials a1 to a6, surfaces of the silicon phases were covered with a coating layer containing lithium silicate, and the coverage rate of the surfaces of the silicon phases with the coating layer was in the range of 40% to 100%. Moreover, the area ratio of the coating layer in a cross section of a particle of the composite material was in the range of 0.01% to 5%.

In Comparative Example 1, in which no additive was used, surfaces of the silicon phases of the composite material b1 were covered with an oxide film.

In Comparative Example 2, in which Li₂CO₃ was used as the additive, surfaces of the silicon phases of the composite material b2 were covered with an oxide film. Note that, since the reducing action of Li₂CO₃ is weak, the surface of the raw material silicon is easily oxidized in the first step. Moreover, since the heat-treating temperature in the second step is 400° C., which is significantly lower than the melting point of Li₂CO₃, the oxide film is not easily converted into lithium silicate. If Li₂CO₃ is used as the additive in the second step and heat-treating is performed at a temperature as high as 850° C. or more, the oxide film can be converted into silicate. However, when not only the heat treating in the second step but also the heat treating in the third step are performed at high temperatures, the crystallinity of the silicate is enhanced excessively, and the ion conductivity tends to be lowered.

In Comparative Example 3, in which Li₂O was used as the additive, likewise in the composite material b2, surfaces of the silicon phases in the composite material b3 were covered with an oxide film.

### INDUSTRIAL APPLICABILITY

The secondary battery according to the present disclosure is useful as a main power source for mobile communication devices, portable electronic devices, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: electrode group, 2: positive electrode lead, 3: negative electrode lead, 4: battery case, 5: sealing plate, 6: negative electrode terminal, 7: gasket, 8: sealing plug, 20: composite material particle, 21: carbon phase, 22: silicon phase, 23: coating layer

1. A negative electrode active material for secondary batteries, comprising
a composite material, wherein
the composite material includes a carbon phase, and silicon phases dispersed in the carbon phase,
at least a part of surfaces of the silicon phases is covered with a coating layer, and
the coating layer contains a lithium silicate.

2. The negative electrode active material for secondary batteries according to claim 1, wherein the coating layer contains at least one element A selected from the group consisting of aluminum and boron.

3. The negative electrode active material for secondary batteries according to claim 2, wherein a content of the element A in the composite material is 0.02 mass % or more and 1.1 mass % or less, relative to a total mass of the composite material.

4. The negative electrode active material for secondary batteries according to claim 1, wherein a content of the silicon phases in the composite material is 50 mass % or less, relative to a total mass of the composite material.

5. The negative electrode active material for secondary batteries according to claim 1, wherein the lithium silicate includes at least one selected from the group consisting of Li₂Si₂O₅, Li₂SiO₃, and Li₄SiO₄.

6. The negative electrode active material for secondary batteries according to claim 1, wherein in a cross section of a particle of the composite material, a coverage rate of the surfaces of the silicon phases with the coating layer is 40% or more.

7. The negative electrode active material for secondary batteries according to claim 1, wherein an area ratio of the coating layer in a cross section of a particle of the composite material is 0.01% or more and 5% or less.

8. A secondary battery, comprising
a positive electrode, a negative electrode, and an electrolyte, wherein
the negative electrode includes the negative electrode active material for secondary batteries according to claim 1.

9. A method for producing a negative electrode active material for secondary batteries, the method comprising:
a first step of adding at least one additive selected from the group consisting of LiAlH₄ and LiBH₄ to a raw material silicon and performing a pulverization treatment, in an inert atmosphere;
a second step of heat-treating a mixture of the raw material silicon and the additive having been subjected to the pulverization treatment, in an inert atmosphere, to convert a surface of the raw material silicon into lithium silicate; and
a third step of adding a carbon source to the raw material silicon with the surface converted into lithium silicate and performing a composite formation treatment, in an inert atmosphere.

10. The method for producing a negative electrode active material for secondary batteries according to claim 9, wherein a heat-treating temperature in the second step is 270° C. or higher and 500° C. or lower.

11. The method for producing a negative electrode active material for secondary batteries according to claim 9, wherein in the first step, the additive is added in an amount of 0.1 parts by mass or more and 3 parts by mass or less per 100 parts by mass of the raw material silicon.
